(19) United States
(12) Patent Application Publication
(10) Pub. No.: US 2009/0237849 A1
(43) Pub. Date: Sep. 24, 2009

(54) Apparatus for preventing surge

(76) Inventor: Chian-Ren Hsieh, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,501

(22) Filed: Feb. 24, 2009

(30) Foreign Application Priority Data
Mar. 19, 2008 (TW) 97109713

(51) Int. Cl. H02H 9/00

(52) U.S. Cl. 361/56

(57) ABSTRACT

The apparatus for preventing surge comprises a bypass element and a capacitor. The bypass element is disposed in an encapsulated circuit, where the encapsulated circuit has a core circuit, wherein one end of the bypass element is electrically coupled with a direct current power supply and another end of the bypass element is electrically coupled with the core circuit. The capacitor is electrically coupled with said another end of the bypass element, where the encapsulated circuit is disposed between the direct current power supply and the capacitor.

### RELATED APPLICATIONS

This application claims priority to Taiwan Application Serial Number 97109713, filed Mar. 19, 2008, which is herein incorporated by reference.

### BACKGROUND

1. Field of Invention

The present invention relates to circuitry. More particularly, the present invention relates to apparatus for preventing surge.

2. Description of Related Art

Please refer to FIG. 1. FIG. 1 illustrates a conventional circuit. In FIG. 1, a direct current power supply (dc power supply) 140 can be connected to the anode of the diode 120; an encapsulated circuit 110 and a capacitor 130 connect in parallel, where the capacitor 130 is disposed between the diode 120 and the encapsulated circuit 110.

When hot plug is performed, the direct current power supply 140 makes contact at point “a” and thereby rapidly provides voltage; therefore, the encapsulated circuit 110 receives a surge with peaking voltage in a very short time. Thus, the peaking voltage may damage the encapsulated circuit 110 when the peaking voltage exceeds the rated voltage of the encapsulated circuit 110.

The voltage at point “a” rises rapidly and thereby a large current flows into the capacitor 130 instantly while the direct current power supply 140 connects the anode of the diode 120. The formula for charging the capacitor is i=C×dv/dt, in which “i” represents the current flowing into the capacitor 130, “dv” represents variation of the voltage, “dt” represents the period during the voltage is rising. For example, the capacitance of the capacitor 130 is 1 microfarad and the voltage rises from 0V to 5V, which needs only 1 microsecond; therefore, the current instantly flowing into the capacitor 130 is 5 A.

Please refer to FIG. 2. FIG. 2 is a timing diagram of the conventional circuit of FIG. 1. In the first stage 210, the voltage at point “a” rises from 0V to the threshold voltage 212 of the diode 120 so that the diode 120 is turned on. In the second stage 220, the voltages at point “a” and “b” rise rapidly and thereby the current “I” rises rapidly as a result of the large current flowing into the capacitor 130. In the third stage 230, the voltage at point “a” is steady, but IS the current “I” doesn't reduce instantly due to the parasitic inductance 152, 154,156 in the conducting wire; therefore, the unnecessary current charges the capacitor 130 too much and thereby the voltage at point “b” continues rising to form the surge 234. In the forth stage 240, the current “I” reduces to the normal current level, and the voltage at point “b” gradually reduces the normal 20 voltage level. At this time, the voltage at point “a” minus the threshold voltage 212 of the diode 120 leaves the voltage at point “b”. The current 242 is used for providing the encapsulated circuit 110. It should be noted that the surge 234 usually exceeds the rated voltage of the encapsulated circuit 110; therefore, the encapsulated circuit 110 may be damaged.

Please refer to FIG. 3. FIG. 3 illustrates a conventional constant voltage circuit for preventing the surge. The conventional constant voltage circuit in FIG. 3 is similar to the conventional circuit in FIG. 1, except that a Zener diode 310 and the capacitor 130 connect in parallel is added. The Zener diode 310 is capable of clamping the voltage at point “b” when the voltage exceeds the breakdown voltage of the Zener diode 310. However, for using the Zener diode 310, the production cost is increased and the Zener diode 310 occupies large space. Alternatively, the encapsulated circuit 110 can endure the surge by means of increasing the rated voltage of the encapsulated circuit 110. However, the area of the encapsulated circuit 110 is large and the production cost is increased.

For the foregoing reasons, there is a need for an apparatus for preventing surge. The present invention meets this need.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to an apparatus for preventing surge.

According to one embodiment of the present invention, the apparatus for preventing surge comprises a bypass element and a capacitor. The bypass element is disposed in an encapsulated circuit, where the encapsulated circuit has a core circuit, wherein one end of the bypass element is electrically coupled with a direct current power supply and another end of the bypass element is electrically coupled with the core circuit. The capacitor is electrically coupled with said another end of the bypass element, where the encapsulated circuit is disposed between the direct current power supply and the capacitor.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 illustrates a conventional circuit;

FIG. 2 is a timing diagram of the conventional circuit of FIG. 1;

FIG. 3 illustrates a conventional constant voltage circuit for preventing the surge;

FIG. 4 shows a block diagram of an apparatus for preventing surge in accordance with one embodiment of the present invention;

FIG. 5A, FIG. 5B, FIG. 6A and FIG. 6B illustrate the bypass element of FIG. 4 respectively; and

FIG. 7 is a timing diagram of the apparatus of FIG. 4.

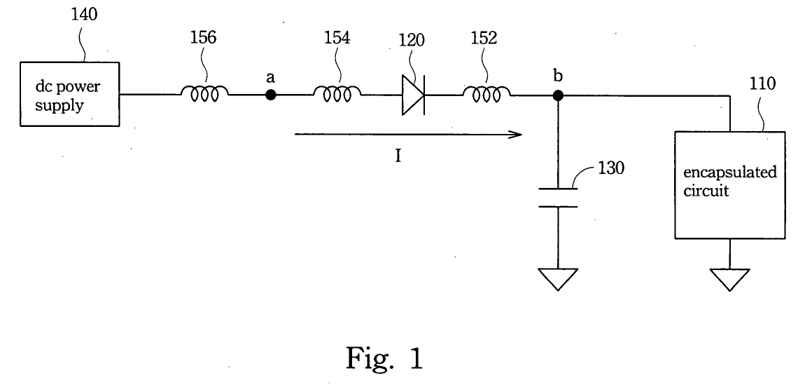

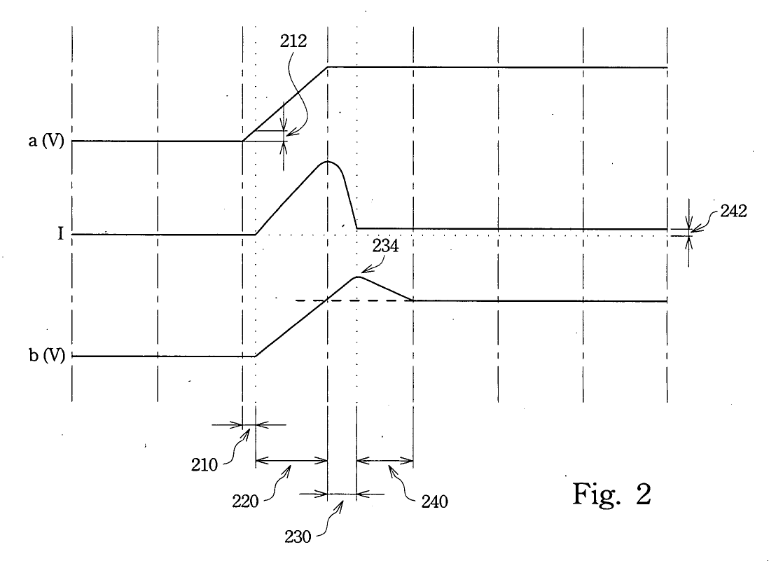

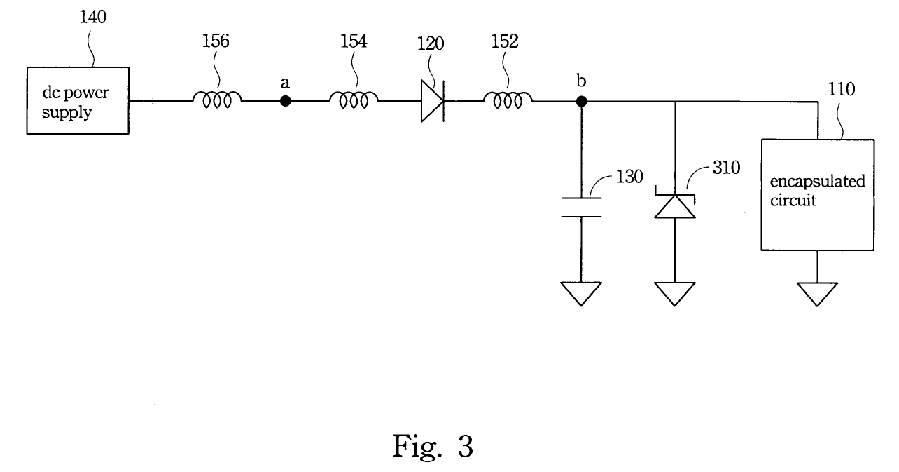

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

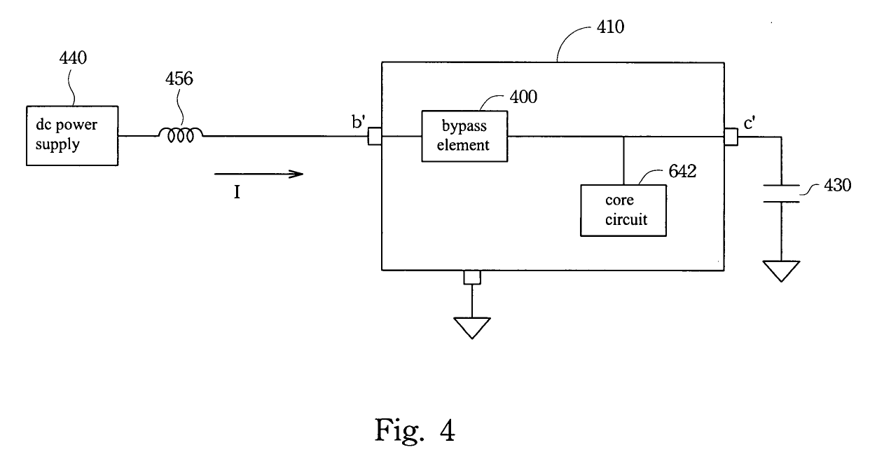

Please refer to FIG. 4. FIG. 4 shows a block diagram of an apparatus for preventing surge in accordance with one embodiment of the present invention. In FIG. 4, the apparatus comprises a bypass element 400 and a capacitor 430. The bypass element 400 disposed in an encapsulated circuit 410. The encapsulated circuit 400 has a core circuit 642. One end of the bypass element 400 is electrically coupled with a direct current power supply (dc power supply) 440, and another end of the bypass element 400 is electrically coupled with the core circuit 642. The capacitor 430 is electrically coupled with said another end of the bypass element 400. It should be noted that the encapsulated circuit 410 is disposed between the direct current power supply 440 and the capacitor 430.

The capacitor 430 can store at least one electric charge form the direct current power supply 440 via the bypass element 400. Additionally, the capacitor 430 can discharge the electric charge to the core circuit 642. The core circuit 642 may be a motor driver, a switching regulator, an audio amplifier or the like. When switching output stage, the core circuit 642 may generate a reverse current, and then the capacitor 430 can absorb the reverse current from the core circuit 642. Furthermore, a diode may be disposed at the output terminal of the direct current power supply 440 to prevent the reverse current.

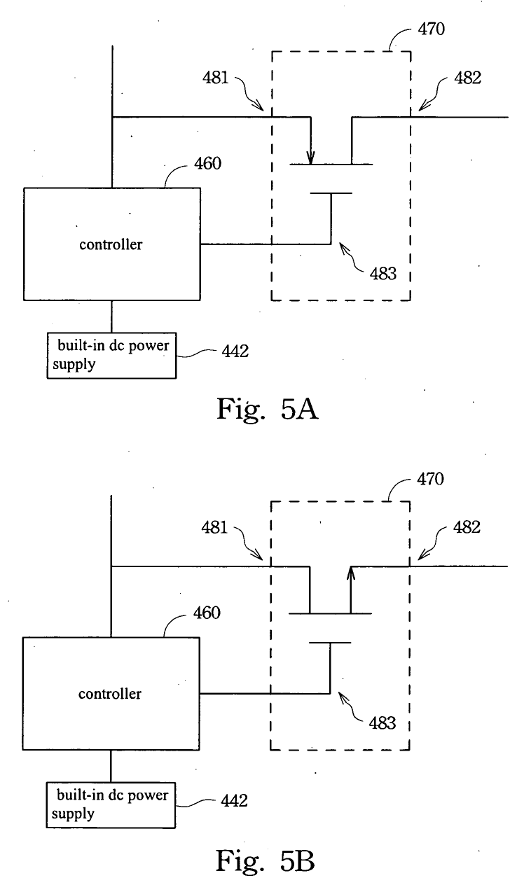

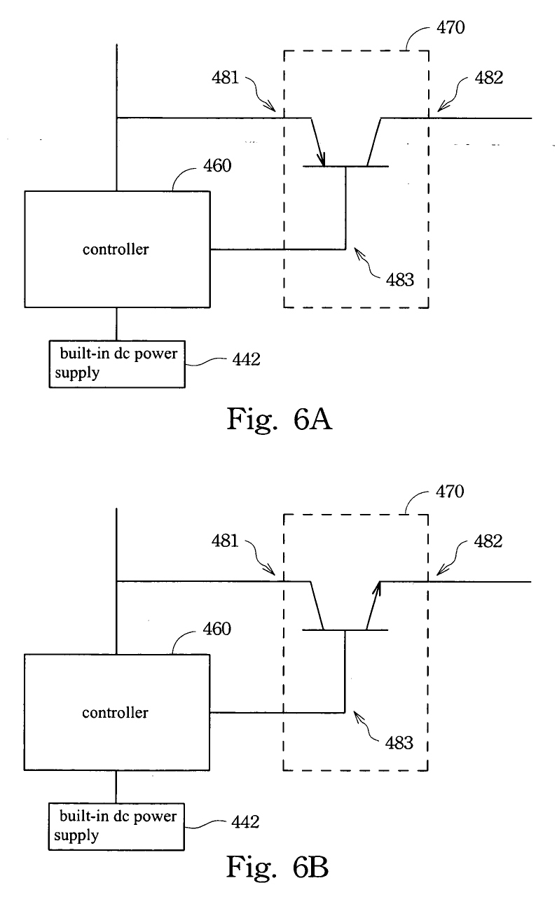

Please refer to FIG. 5A, FIG. 5B, FIG. 6A and FIG. 6B. FIG. 5A, FIG. 5B, FIG. 6A and FIG. 6B illustrate the bypass element of FIG. 4 respectively. In FIG. 5A, FIG. 5B, FIG. 6A and FIG. 6B, the bypass element 400 comprises a controller 460 and a controlled switch 470. The controlled switch 470 is disposed in the encapsulated circuit 410. The controlled switch 470 comprising a first end 481, a second end 482 and a third end 483, where the first end 481 is electrically coupled with the direct current power supply 440 and the second end 482 is electrically coupled with the capacitor 430. The controller 460 is disposed in an encapsulated circuit 410, where one end of the controller 460 is electrically coupled with the direct current power supply 440 and another end of the controller 460 is electrically coupled with the third end 483 of the controlled switch 470.

It should be noted that the controlled switch 470 can separate the parasitic inductance 456 in the conducting wire and the capacitor 430. For example, the controller 460 can electrically connect the first end 481 and the second end 482 of the controlled switch 470 when said one end of the controller 460 receives positive electricity from the direct current power supply 440. On the contrary, the controller 460 can electrically disconnect the first end 481 and the second end 482 when the one end of the controller 460 doesn't receive the positive electricity from the direct current power supply 440. Furthermore, the bypass element 400 may comprises a built-in direct current power supply 442. The built-in direct current power supply 442 is electrically coupled with the controller 460 for providing power to the controller 460, whereby the controller 460 can execute above-mentioned operation.

In FIG. 5A, the controlled switch 470 is a p-channel metal-oxide-semiconductor, where the first end 481 of the controlled switch 470 is the source of the p-channel metal-oxide-semiconductor; the second end 482 of the controlled switch 470 is the drain of the p-channel metal-oxide-semiconductor; the third end 483 of the controlled switch 470 is the gate of the p-channel metal-oxide-semiconductor. The controller 460 can control the voltage of the gate to turn on/off the controlled switch 470.

In FIG. 5B, the controlled switch 470 is an n-channel metal-oxide-semiconductor, where the first end 481 of the controlled switch 470 is the drain of the n-channel metal-oxide-semiconductor; the second end 482 of the controlled switch 470 is the source of the n-channel metal-oxide-semiconductor; the third end 483 of the controlled switch 470 is the gate of the p-channel metal-oxide-semiconductor. The controller 460 can control the voltage of the gate to turn on/off the controlled switch 470.

In FIG. 6A, the controlled switch 470 is a PNP bipolar transistor, where the first end 481 of the controlled switch 470 is the emitter of the PNP bipolar transistor; the second end 482 of the controlled switch 470 is the collector of the PNP bipolar transistor; the third end 483 of the controlled switch 470 is the base of the PNP bipolar transistor. The controller 460 can control the voltage of the base to turn on/off the controlled switch 470.

In FIG. 6B, the controlled switch 470 is an NPN bipolar transistor, where the first end 481 of the controlled switch 470 is the collector of the NPN bipolar transistor; the second end 482 of the controlled switch 470 is the emitter of the NPN bipolar transistor; the third end 483 of the controlled switch 470 is the base of the NPN bipolar transistor. The controller 460 can control the voltage of the base to turn on/off the controlled switch 470.

In other embodiment, the controlled switch 470 may be a low drop-out linear voltage regulator or the like. The bypass element 400 may be an impedance component or a conductor, such as a metal wire. One of ordinary skill in the art will appreciate that the above examples are provided for illustrative purposes only to further explain applications of the present invention and are not meant to limit the present invention in any manner. Other material of the bypass element 400 may be used as appropriate for a given application.

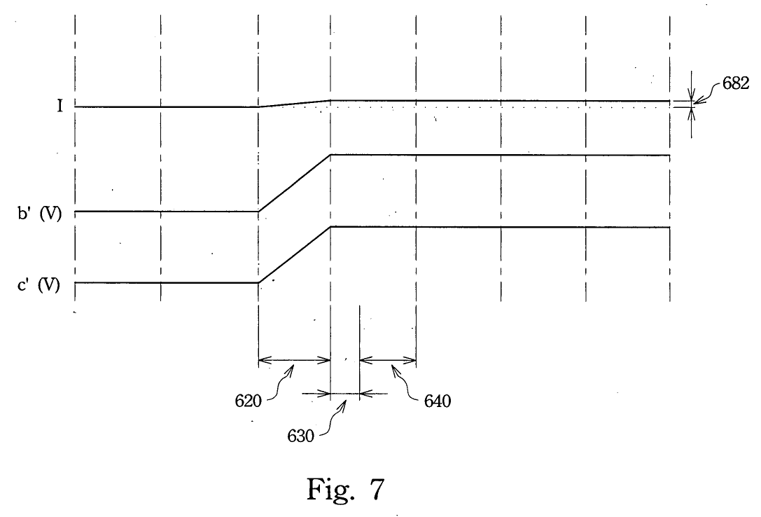

For a more complete understanding of the present invention, and the advantages thereof, please refer to FIG. 7 and FIG. 4. FIG. 7 is a timing diagram of the apparatus of FIG. 4. In the first stage 620, the controlled switch 470 control the voltage output and the current output at point c′; the voltages and the current at point b′ and c′ synchronously rise to steady. In the second stage 630 and the third stage 640, the current is steady without surge because there is no capacitor that is disposed between the direct current power supply 440 and point b′. The current 682 is used for providing the encapsulated circuit 410. The voltage drops of the bypass element 400 plus the voltage at point c′ equals the voltage at point b′.

It will be apparent to those skilled in the art that various modifications and variations can be made to the structure of the present invention without departing from the scope or spirit of the invention. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. An apparatus for preventing surge, comprising:
a bypass element disposed in an encapsulated circuit, wherein the encapsulated circuit has a core circuit, wherein one end of the bypass element is electrically coupled with a direct current power supply and another end of the bypass element is electrically coupled with the core circuit; and
a capacitor electrically coupled with said another end of the bypass element, wherein the encapsulated circuit is disposed between the direct current power supply and the capacitor.

2. The apparatus of claim 1, wherein the capacitor for storing at least one electric charge form the direct current power supply via the bypass element.

3. The apparatus of claim 2, wherein the capacitor for discharging the electric charge to the core circuit.

4. The apparatus of claim 1, wherein the capacitor for absorbing a reverse current from the core circuit.

5. The apparatus of claim 1, wherein the bypass element further comprises:
a controlled switch comprising a first end, a second end and a third end, wherein the first end is electrically coupled with the direct current power supply and the second end is electrically coupled with the capacitor; and
a controller disposed in an encapsulated circuit, wherein one end of the controller is electrically coupled with the direct current power supply and another end of the controller is electrically coupled with the third end.

6. The apparatus of claim 5, wherein the controller electrically connects the first end and the second end when the one end of the controller receives positive electricity from the direct current power supply.

7. The apparatus of claim 1, wherein the controller electrically disconnects the first end and the second end when the one end of the controller doesn't receive the positive electricity from the direct current power supply.

8. The apparatus of claim 5, wherein the controlled switch is a metal-oxide-semiconductor, wherein the third end is the gate of the metal-oxide-semiconductor.

9. The apparatus of claim 5, wherein the controlled switch is a bipolar transistor, wherein the third end is the base of the bipolar transistor.

10. The apparatus of claim 5, further comprising:
a built-in direct current power supply electrically coupled with the controller for providing power to the controller.

11. The apparatus of claim 1, wherein the bypass element is an impedance component.

12. The apparatus of claim 1, wherein the bypass element is a conductor.
